(19) United States
(12) Patent Application Publication
(10) Pub. No.: US 2026/0120307 A1
(43) Pub. Date: Apr. 30, 2026

(54) Integrated Weight and Dimension Measurement System

(71) Applicant: Yongxian Feng, Santa Clara, CA (US)

(72) Inventor: Yongxian Feng, Santa Clara, CA (US)

(21) Appl. No.: 18/927,903

(22) Filed: Oct. 26, 2024

(51) Int. Cl. G06T 7/62; G01G 3/14; G01G 21/22

(52) U.S. Cl. CPC G06T 7/62; G01G 3/14; G01G 21/22; G06T 2200/24

(57) ABSTRACT

One implementation provides a device and method for the simultaneous measurement of weight and dimensions of an object, enhancing efficiency by integrating these processes into a single step. One implementation encompasses a flat platform weight scale base containing load cells that ascertain the object's weight. It also features image sensors for capturing images from different angles to determine the object's length, width, and height through image analysis. The processor computes weight from load cell readings and applies image processing to assess object dimensions. This data can be displayed or transmitted, often wirelessly, for external usage, beneficial for industries requiring precise weight and size information to streamline various processes such as logistics and inventory management.

### BACKGROUND OF THE INVENTION

This invention relates to the field of measurement devices.

In the fast-paced world of logistics and inventory management, the ability to quickly and accurately measure the weight and dimensions of packaged goods is essential for optimizing storage space, calculating shipping costs, and streamlining supply chain operations. Traditionally, weight measurement and dimensional analysis have been conducted through separate processes or devices, resulting in increased time consumption and potential for human error, and often requiring extensive manual data entry. The integration of these measurement processes into a single system offers a promising solution for enhancing efficiency, reducing labor, and improving accuracy in material handling and shipping industries. Such advancements not only have the potential to transform warehouse operations but also align with the increasing automation trend where data-driven insights are pivotal for operational decision-making.

The current automatically measurement of dimension is through either laser or ultrasonic sensors. Those active sensors are transmitting a signal and wait from the reflection of the signal or the bouncing back of the signal. They are only one dimensional measurement and results in very complicated two or three-dimensional measurement. This invention is digital image-based automatic measurement device that can cover all three-dimensional measurement and weight simultaneously and therefore greatly simplify or even eliminate the sensor setup in all three dimensional measurements used by other methods.

### SUMMARY OF THE INVENTION

In one aspect, one implementation encompasses a multifunctional measurement device consisting of a flat platform weight scale base equipped with one or more load cells to gauge the weight of an object. Accompanying this base are image sensors designed to photograph the object in question. A processor is tasked with interpreting the signals from the load cells to ascertain the object's weight, applying image processing to the captured imagery, and utilizing image recognition algorithms to deduce the dimensions of the object, such as its length, width, and height. Moreover, the device includes a digital interface to exhibit, send, store, and facilitate distant processing of both the raw data and the processed figures.

In another aspect, the method includes the use of a flat platform weight scale base equipped with load cells for measuring the weight of an object. Image sensors positioned around the weight scale capture images of the object, and signals from the load cells are processed to determine its weight. Image processing techniques are applied to the captured images to ascertain the length, width, and height of the object.

In a further aspect, a device can simultaneously measure the weight and dimensions of objects. The device integrates a weight scale with a dimension measuring unit, which may use one or more 2D imaging sensors, infrared sensors, or radar to capture the image of an object and then use image processing and machine learning algorithms to determine or measure the length, width, and height of that object. This integration enables fast, accurate and automatic measurements, streamlining processes in industries such as shipping, logistics, packaging, airport luggage check-in, post office, freight companies, forklifts, warehouses, conveyer belts, and manufacturing.

In implementations, the image processing and machine learning algorithms use corner points, edges, and surface planes from the object image with mathematical algorithm to determine the length, width, and height of the object. The device includes a digital interface for displaying and transmitting the measured data to external systems for further processing, thereby reducing the need for manual data entry and minimizing errors. The data is transmitted via wired or wireless connection to a local or cloud server. The image processing is performed on an imbedded microcomputer, or microprocessor, or local server computer, or a cloud computer.

The multifunctional measurement device presents several key advantages, which may include, but are not limited to, the following:

Streamlined Operations: By combining weight and dimensional measurements into a single process, the device simplifies logistics procedures, making operations more efficient and reducing the time it takes to prepare items for storage or shipment.

Increased Accuracy: The use of load cells and image processing algorithms minimizes human error associated with manual measurements and data entry, thereby enhancing the accuracy of the weight and dimensional data.

Cost Efficiency: The integration of two measurement functions into one device may lead to cost savings by reducing the need for multiple separate systems and the manpower required to operate them.

Space Conservation: The single-device approach saves space within a logistics facility because it requires less room than separate weight and dimension measurement systems, allowing for more effective use of the available workspace.

Enhanced Data Management: With its digital interface, the device allows for instant digital recording and management of data, facilitating better tracking, auditing, and inventory control.

Improved Shipping and Handling: Accurate weight and dimensional data enable more precise calculations of shipping costs and optimization of transport and storage space, leading to potential reductions in overhead and freight expenses.

Automation Readiness: The device aligns with the trend toward automation and smart technology in warehousing, offering seamless integration with warehouse management systems (WMS) and the Internet of Things (IoT) to further automate supply chain operations.

Scalability: As businesses grow, the device can easily scale to meet increased demand without significant changes to existing workflows or the need for extensive retraining of personnel.

Eco-Friendly: More accurate measurements may lead to better space utilization in shipping containers and trucks, which could result in fewer trips and reduced carbon emissions due to more efficient loading.

Quality of Service: Enhanced accuracy and efficiency may lead to higher customer satisfaction, as shipping errors decrease and items are received in good condition due to appropriate handling based on exact measurements.

Easy Integration: The device's design can be made compatible with existing systems and equipment, reducing the barrier to adoption and facilitating technology upgrades.

Full Feature: The electromechanical system or device can automatically and simultaneously measure and record the weight and 3D dimensions of objects for use in shipping, logistics, packaging, airport luggage check-in, post office, freight company, forklifts, warehouses, convey belts, and manufacturing.

These advantages not only represent improvements in technological capability but also reflect the potential impact on business operations, environmental concerns, and the broader logistics industry.

### BRIEF DESCRIPTION OF DRAWINGS

Turning now descriptively to the drawings, in which similar reference characters denote similar elements throughout the several views, the figures illustrate the electronic book of the present invention. With regard to the reference numerals used, the following numbering is used throughout the various drawing figures.

FIG. 1 shows an illustration of an exemplary weight and dimension measurement system,

FIG. 2 shows an illustration of the exemplary weight and measurement methodology.

FIG. 3 shows an illustration of weighing and measuring of an exemplary irregular object such as a luggage case.

FIG. 4 shows an illustration of an exemplary calibration process.

FIG. 5 shows an illustration of an exemplary processor for detecting weight and dimensions of an object.

FIG. 6 shows flowchart showing steps for measuring weight and dimensions with image recognition.

### DETAILED DESCRIPTION OF THE INVENTION

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

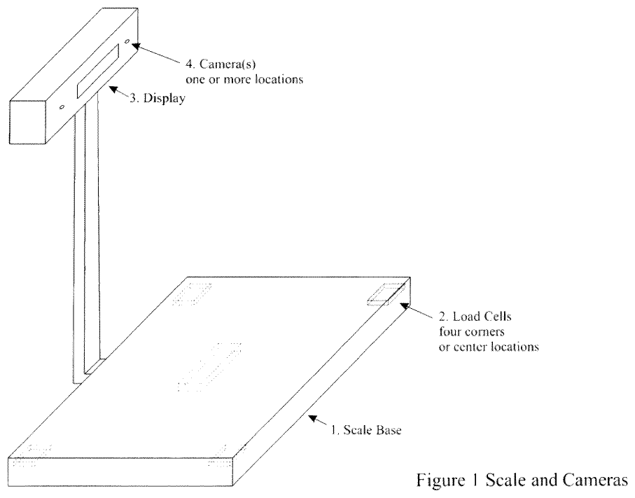

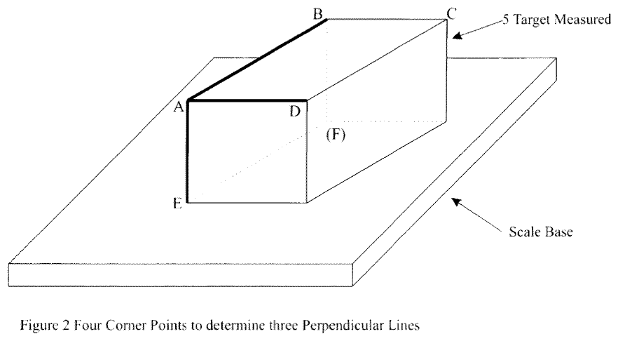

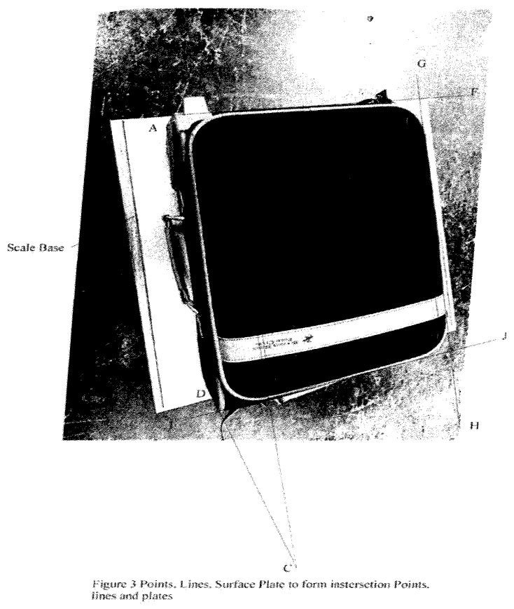

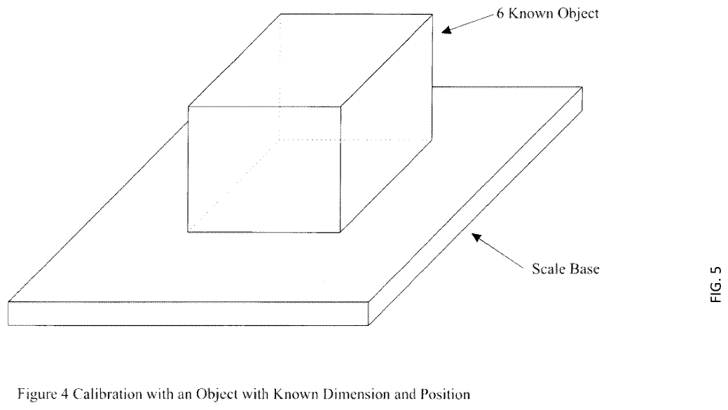

Before diving into details, in brief, FIG. 1 shows an isometric view of the weight and dimension measurement device, including load cell(s) and the image sensor arrangement. The load cells as weighing sensor can be a single load cell located at the center of the platform or multiple load cells located at the corners of the platform, or as well as the edges for a weighing bridge. The image sensor can be a single or multiple cameras, or infrared, mounting on a column, a side wall, or an adjustable arm. FIG. 2 shows a measurement target on top of the scale base for camera to capture its image to determine the dimension of a regular object. By identifying four corner points, for example, A, B, D, E, Lines AB, AD, and AE can then be determined. The length of Line AB is the length, Line AD is the width, and Line AE is the height of the object. FIG. 3 shows a irregular object (here is a luggage) dimension can be also determined by face plate intersections. For example, From Lines AB, and CD, surface plane ABCD which is perpendicular to the scale base platform can be determined. A side surface plane containing Line EF which is the edge of the object and is perpendicular to the scale base can be calculated. So is another side surface plane containing Line IJ. And also is the back surface plane containing Line GH. With these four surface planes, the length and the width of the object can be determined from their intersection lines. The top surface plane which is parallel to the scale base can be calculated by points or lines on the object surface, therefore, the height of the object is defined. FIG. 4 shows that a known dimension object on the scale base surface can be used to calibrate the image processing and algorithms.

Turning now to FIG. 1, an exemplary weight and dimension measurement system includes the following:
1. a scale base,
2. load cells positioned at four corners or central locations,
3. a display, and
4. camera(s) located at one or more positions.

The weight and dimension measurement device consists of a flat platform weighing scale base and a side column or side wall mounted with camera(s), scale indicator, and display, as shown in FIG. 1. The platform is designed to support objects of various shapes and sizes and let the load cell(s) under the platform measure the object weight. The camera(s) are mounted on the column or side wall with various angles and are positioned to capture images of the object. The camera(s) can also be mounted on adjustable arms or fixed position depending on the desired application.

When an object is placed on the platform, the weight is immediately measured by the scale. It simultaneously triggers the camera(s) to capture the images of the object. These images are then processed using image processing algorithms to determine the object's dimensions, including length, width, and height. The system can handle objects of various shapes and sizes, making it versatile for different industries.

This device use camera(s), or infrared, as measurement sensors, through image processing, providing high accurate measurements of the object's dimensions and reduces errors associated with for manual measurements. The data collected by the sensors is processed by an embedded microcontroller(s) or computer, which calculate the object's dimensions and weight. This data is then displayed on a digital interface, which can also transmit the information to an external system via wired or wireless communication protocols.

The device can be powered by an internal rechargeable battery or an external power source, making it versatile for use in various environments, including warehouses, manufacturing floors, airports, post office, freight companies, and shipping centers.

The flat platform weight scale base 1 is a foundational component of the measurement device. It provides a stable surface on which an object can be placed for weighing and dimensional assessment. Integrating seamlessly with the load cells 2, this base is designed to facilitate accurate weight measurements by evenly distributing the object's load, ensuring precision during the measurement process. Its flat design accommodates varied object sizes, making it versatile for different applications. These load cells are positioned either at the four corners or center of the base, allowing them to accurately gauge the weight of the object placed on the scale. The data obtained from the load cells is processed by a dedicated processor to determine the object's weight precisely, forming an integral part of the multifunctional measurement system. The present invention provides a multifunctional measurement device aimed at simultaneously ascertaining the weight and dimensions of an object, thereby streamlining logistical operations such as packaging, shipping, and storage. The core of this invention lies in its versatile approach to measuring attributes by incorporating a weight detection system in concert with a dimension detection system, allowing for simultaneous determination of an object's physical properties.

The device is constituted by a flat platform weight scale base 1 that is integrated with one or more load cells 2, designed for the precise detection of weight. These load cells are calibrated to capture and convert the force exerted by the object into electrical signals that correspond to the mass of the object placed upon the scale 0. The type of load cells can vary and may include, for example, strain gauge load cells, hydraulic load cells, or capacitive load cells, each chosen based on desired accuracy, cost, resistance to environmental factors, and the weight range they are required to measure.

The digital interface 3 not only visually presents the measurements but provides a means for the underlying data and results to be transmitted, stored, or remotely processed. This grants users a fully integrated solution for managing object information and facilitates seamless integration with inventory management systems.

Thus, this invention provides a multi-functional device that significantly improves upon existing measurement systems by offering a rapid and reliable method for obtaining both the weight and volume metrics, fostering efficiency in various industries that handle physical goods.

The digital interface 3 serves as the communication hub for the multifunctional measurement device. It is designed to display the processed data, such as the weight and dimensions of the object. Additionally, this interface facilitates the transmission and storage of both raw and processed information, enabling remote processing and analysis. The interface integrates seamlessly with the rest of the system, ensuring that the measurement data is easily accessible, enhancing the efficiency of logistics and operational processes.

The system includes one or more cameras, denoted as reference label 4, strategically positioned around the scale to capture images of the object. These cameras work in conjunction with the load cells to provide a comprehensive analysis of both weight and dimensions. The captured images are processed to determine the object's size, including length, width, and height. The integration of these cameras facilitates the multifunctional measurement capabilities of the device by enabling accurate and efficient dimensional assessment in addition to weight measurement.

The flat platform weight scale base 1 serves as the foundation of the multifunctional measurement device, providing a stable and level surface upon which items can be placed for measurement. Incorporated within this base are precision-engineered load cells 2 that are capable of detecting even minute changes in weight. These load cells transform the mechanical force exerted by the weight of the placed object into an electrical signal, which is then conveyed to the processor 50 for accurate weight quantification. The design of the flat platform weight scale base 1 is such that it accommodates objects of varying sizes while maintaining high measurement reliability and repeatability. Its construction is robust to ensure longevity in various operational environments and is versatile for integration with additional measurement technologies, such as the camera-based sensors 4 for dimensional analysis.

According to one implementation, the load cell 2 is integrated into the flat platform weight scale base 1 and is utilized for determining the weight of the target measured 5. The load cell 2 operates by converting force into an electrical signal through its strain gauge, which detects the deformation caused by the weight of the target measured 5 placed on the flat platform weight scale base 1. It is through the precise detection and measurement of this deformation that the load cell 2 is able to provide an accurate assessment of weight. The signal generated by the load cell 2 is then relayed to the processor 50, which interprets it to give a precise weight measurement of the target measured 5. This data can then be displayed on the digital interface 3, enabling clear and immediate visibility of the weight to the user, as well as transmitted for further processing or storage as needed. The functionality of the load cell 2, therefore, forms the foundation for the weight measurement capabilities of the device, contributing to an all-encompassing solution that combines weight assessment with dimensional analysis through the complimentary image capture and processing elements.

FIG. 2 illustrates the reference of four corner points used to determine three perpendicular lines. The illustration in FIG. 2 demonstrates a technique for determining the dimensions of an object 58 using four corner points. A flat platform weight scale base 1 is utilized to support the object. The figure shows the object placed on the base, and the corners of the object are labeled A-F and points A-E are used in establishing three perpendicular lines: AB, AD, and AE. Line AB represents the length, line AD indicates the width, and line AE suggests the height of the object. By processing the visual data captured by camera-based sensors 52 and 54, the system accurately aligns the points to form the perpendicular lines. The precise arrangement of these points ensures accurate computation of the object's dimensions, allowing the processor 50 to analyze and interpret the spatial configuration effectively. This methodology streamlines the dimensional analysis, providing a comprehensive assessment of the object's size for further processing or logistics operations.

FIG. 3 illustrates the points, lines, and surface plates to form intersection points in an irregular object. FIG. 3 illustrates the process of weighing and measuring an exemplary irregular object, such as a luggage case. The system employs camera-based sensors (52, 54) positioned around the flat platform weight scale base 1. These sensors capture images to facilitate the detection of critical points, lines, and surfaces of the object 58. The captured imagery is analyzed using image processing techniques, allowing the processor 50 to recognize the object's contours and dimensions by identifying key intersection points and defining boundary lines. The surface area is assessed by mapping these recognized features to calculate parameters such as length (A), width (G), and height (H), which are imperative for determining the object's volume and spatial characteristics. This integrated approach ensures precise measurement of both weight and dimensions, enhancing the functionality of the multifunctional measurement device.

FIG. 4 illustrates the calibration process using an object with known dimensions and position. In one aspect of the method, the system utilizes known object 6 for calibration. This known object is employed to ensure that the scale and imaging systems are accurately configured to measure the weight and dimensions of the target measured 5. By integrating these measurements of known reference objects, the device operation can be tested. For the purpose of system calibration and ensuring measurement accuracy, the device takes advantage of test objects 6 with known dimensions and a standard weight. These are standardized weight traceable to NIST, a, and their utilization is critical for the calibration process. The known and precise dimensions of the test objects 6 are used to calibrate the image sensors (52, 54) and refine the image recognition algorithms, while their known weights serve to adjust the load cells 2, guaranteeing high precision in weight assessments. By regularly calibrating the system using a standard dimension object 6 and a standard weight traceable to NIST, the device maintains its accuracy and reliability, ensuring consistent performance over time and across a multitude of environmental factors.

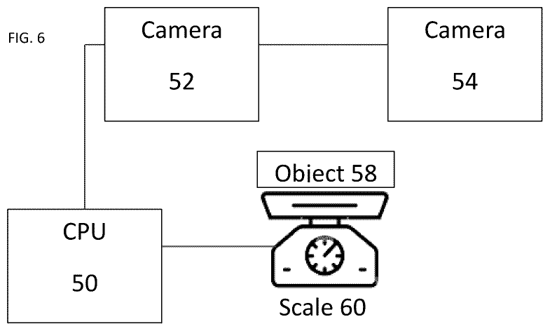

FIG. 5 illustrates the CPU 50 connected to cameras 52 and 54, and a scale displaying object 58. The multifunctional measurement device incorporates a processor 50 tasked with interpreting signals from one or more load cells to accurately measure the weight of a target object 58. Additionally, the processor 50 processes images captured by the camera-based sensors (52 and 54) to determine the dimensions of the target object. Through image recognition algorithms, the processor 50 deduces the object's length, width, and height. The device seamlessly integrates these measurements and utilizes a digital interface 3 for displaying, transmitting, and storing both raw and processed data, thereby streamlining operations and enhancing efficiency in logistics processes.

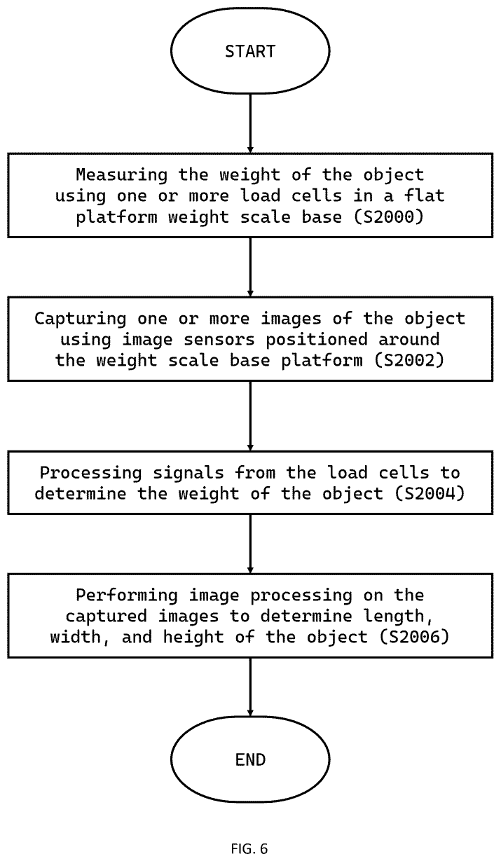

FIG. 6 illustrates the following steps for measuring weight and dimensions using image recognition:

Capturing one or more images of the object using image sensors positioned around the weight scale base platform.

Processing signals from the load cells to determine the weight of the object.

Performing image processing on the captured images to determine the length, width, and height of the object.

A processor, serving as the computational core of the device, is intricately connected to both the load cells and the image sensors. The processor is tasked with multiple key functions in the measurement process. Firstly, it processes the electronic signals emanating from the load cells to ascertain the weight of the object. Following this, the processor engages in image processing tasks using the images captured by the image sensors. This image processing includes analyzing the visual data to ensure that the images are of sufficient quality for assessing the object's dimensions.

Subsequently, the processor performs image recognition functions, which are at the forefront of the device's innovativeness. This process entails recognizing the contours and edges of the object within the captured images. Using advanced algorithms, the processor determines the length, width, and height of the object from these images. Through this sophisticated processing and recognition capability, the device provides a comprehensive and meticulous analysis of the object's dimensions.

The detailed description elucidated above showcases the multifaceted nature of the measurement device, its components, and its functionality. The device's capability to simultaneously capture the object's weight and dimensions, combined with the enhanced processor and digital interface, positions it as a comprehensive measurement tool, pivotal for a wide range of applications across various industries. The precise execution of tasks by the processor, harnessing advanced image recognition techniques, underscores the technological advancement and the patentability of this one implementation. Users of the device will benefit from real-time, accurate weight and dimension data, enabling more efficient workflows and decision-making processes.

In some embodiments of the integrated measurement system, image sensors are employed that may be either camera-based or infrared-based. These image sensors are utilized to precisely capture various parameters that aid in the measurement of an object's volume. Camera-based sensors leverage optical imaging to capture detailed images of the target that are then processed to determine dimensions. The images captured by the camera-based sensors can include a series of two-dimensional images taken from various angles around the object. These multiple views are then processed using photogrammetry or similar techniques to create a three-dimensional representation of the object.

Infrared-based sensors, on the other hand, detected the heat signatures by measuring infrared radiaction emitted by the object. It can then be used to reconstruct the three-dimensional shape and size of the object.

Furthermore, the system may use both camera-based and infrared-based sensors in concert to enhance the measurement accuracy and robustness, especially in diverse lighting conditions or when dealing with objects that have complex geometries or reflective surfaces.

The measurement system's processor plays a critical role in processing the data obtained from these image sensors. Upon receiving the raw data, the processor executes programmed instructions to perform computational tasks. These tasks include image processing, edge detection, and data fusion where inputs from both camera-based and infrared-based sensors are combined. After processing the images and sensor data, the processor employs algorithms designed to calculate the volume of the object based on the processed input. These algorithms take into account the calibration information, where the known object with predetermined dimensions is used as a reference, ensuring the system maintains high measurement accuracy.

In calculating volume, the three-dimensional representation, whether derived from camera-based images or from infrared sensor data, is typically processed to identify the perimeters and surface points which define the physical boundaries of the object. The volume is then calculated by integrating the space confined within these boundaries.

The integration of camera-based and infrared-based sensors in the measurement system enables the device to robustly measure the volume of the target regardless of the environmental conditions or the material properties of the object. The combined use of these technologies leads to a versatile system that can provide reliable and precise volume measurements promptly, which is especially beneficial in industrial settings where throughput and accuracy are paramount.

Adding to the versatility of the system, the load cells integrated into the flat platform weight scale base seamlessly work in conjunction with the image sensors. As the weight of the object is measured by the load cells, the same object is simultaneously scanned by the image sensors for volume measurement. The dual-measurement capability of the system, enabled by the sophisticated processing of the processor, significantly streamlines the measurement process by providing both weight and volume data through a single interaction with the target object. This eliminates the need for sequential or separate measurement processes, enhancing the efficiency and productivity in environments such as shipping facilities, warehouse inventory management, and manufacturing quality control.

In addition to measuring weight and volume, the system may also be configured to calculate additional parameters such as the density of the object. This is achieved by using the known weight and volume to perform a simple density calculation, providing further insight into the material properties of the target measured, which can be essential in various applications such as material sorting or quality assessment.

One or more load cells are operably connected to the flat platform weight scale base. These load cells are precision instruments designed to measure the weight of the target measured placed on the scale base. The weight data detected by the load cells is converted to electrical signals which can be further processed for displaying or recording the weight information.

A digital interface is operably connected to the one or more load cells, serving as the user interface for the measurement system. This interface provides a visual readout of the weight information and may also offer additional functionality, such as data logging, unit conversion, or network connectivity for remote monitoring and data sharing.

One or more cameras are positioned in strategic locations around the platform weight scale base to capture images of the target measured from various angles. These images are essential for determining the volume of the object and may employ varying levels of sophistication, including 2D imaging or 3D reconstruction techniques to ensure accurate volume measurements.

In order to enhance the accuracy and reliability of the volume measurements, the system may be equipped with camera-based sensors. These sensors work in conjunction with the cameras and may employ various technologies such as laser triangulation, structured light, or stereoscopic methods to more precisely measure the dimensions of the target measured.

Calibration of the measurement system is achieved using a known object with predetermined dimensions. This known object is used to calibrate the cameras and camera-based sensors, ensuring that volume measurements are accurate and consistent. The calibration process corrects for any optical distortions or inaccuracies inherent in the cameras or sensors, and may be performed periodically to maintain the measurement system's precision.

The measurement system benefits from an integrated design that improves the workflow and data consistency by combining weight and volume measurement into a single automated process. The addition of a conveyor to deliver the object to the weight scale base streamlines the measurement process further, making the system particularly well-suited for high-throughput industrial applications where efficiency and accuracy are critical.

Upon activation by the signal from the load cells, the cameras are prompted to capture images of the object. These cameras are arranged in such a manner as to obtain multiple perspectives of the target measured, ensuring that all necessary dimensions are captured for an accurate volume measurement. The images obtained are processed by a processor which employs sophisticated algorithms to calculate the volume of the object. The processor analyzes the images to determine contours, shapes, dimensions, and any other relevant features necessary to ascertain the volume of the target measured.

This system is further enhanced by the inclusion of camera-based sensors which supplement the imaging capacity of the cameras. These sensors provide additional data points and augment the precision of the cameras, contributing to a more accurate volume measurement. The camera-based sensors work in conjunction with the cameras and are activated simultaneously with the image capture sequence instigated by the load cells.

The system brings forth advancements by providing an all-encompassing solution for a quick and reliable acquisition of both weight and volume data for an object. Such integration facilitates a breadth of applications, including but not limited to shipping and handling, inventory management, and material analysis. It enables the calculation of density when both the weight and volume are known, offering further insights into the characteristics of the target measured, which may be of considerable interest in various industrial and commercial practices.

Furthermore, the digital interface associated with the measurement system presents the weight information in an easily accessible manner while also permitting the user to interface with the system for additional functionalities such as recalibration, data logging, and potentially, network connectivity for remote monitoring and data analysis. The integration of such features enhances the user experience, providing a comprehensive tool for accurate physical assessment of objects in a multitude of contexts.

The described measurement system further includes a wireless communication module. The wireless communication module is integrated within the measurement system and is operably connected to the processor. This module enables the system to transmit the data related to the weight and volume measurements taken by the load cells and cameras, respectively, to an external system or cloud-based service for storage, further analysis, or real-time monitoring.

The wireless communication module may employ various known wireless communication standards, including but not limited to, Wi-Fi, Bluetooth, NFC, ZigBee, or cellular networks. The choice of communication standard can be based on the desired range, data rate, power consumption, and existing infrastructure of the user environment.

Upon measuring the weight and volume of the target measured, the processor processes this information to determine additional parameters such as density, if required. The resultant data, along with the raw weight and volume measurements, are then formatted into a data packet structure suitable for wireless transmission. This can include securing the data using encryption or other security measures to ensure confidentiality and integrity during transmission.

Once prepared, the data packet is sent by the wireless communication module to a predetermined internet-enabled device, server, or cloud-based storage system. This transfer allows users or systems to access the data remotely, facilitate long-term data logging, variable threshold alerts, analysis for optimization in supply chain management, inventory control, quality assessment, and other applications.

Furthermore, the external system receiving the data can provide additional functionality, such as inventory management, by automatically updating inventory databases with the measured weight and volume information. Additionally, when connected to a cloud-based system with analytics capabilities, the data can be used to generate predictive maintenance schedules for the measurement system, identify trends, and improve operational decisions using artificial intelligence or machine learning algorithms.

Implementation of the wireless communication module ensures convenient and efficient data management, making the measurement system highly adaptable to various modern industrial and commercial environments. Users can leverage the module for seamless integration into existing IT infrastructure and Internet of Things (IoT) ecosystems, facilitating a high degree of automation and interconnectedness with other systems and devices.

One implementation comprises an integrated measurement system designed to determine the weight and volume of an object with improved accuracy and efficiency. The system includes a flat platform weight scale base upon which the object to be measured is placed. The base integrates one or more load cells that are configured to measure the weight of the object. The weight information is communicated to a digital interface, which displays the recorded weight to the user.

In addition to the components necessary to measure weight, the system is equipped with one or more cameras. These cameras are strategically positioned to capture multiple images of the object from different angles. The retrieved images are subsequently processed by a processor that utilizes image recognition techniques to identify various geometric characteristics of the object.

The image recognition focuses on identifying distinct features such as corner points, edges, and surface planes of the object. Once these features are identified, the processor calculates the length, width, and height of the object by analyzing the positions and relationships of these features within the captured images.

The accuracy of the volume measurements depends greatly on the precision of the image recognition process. To this end, the system may employ advanced algorithms capable of discerning subtle characteristics in the images that indicate the boundaries and contours of the object. The processor then uses these identified boundaries and contours to create a virtual model of the object within its computing space.

The virtual model created by the processor is used to calculate the volume of the object. This is achieved by integrating the dimensions derived from the images. The volume of regular or irregular shapes can be computed by the processor by applying geometric principles and algorithms that take into account the complex shapes and forms sometimes exhibited by objects.

The capabilities of the measurement system can be further enhanced with the addition of camera-based sensors, which can augment the data collected by the cameras. These sensors could, for example, include structured light projectors, depth sensors, or laser scanners to assist in obtaining precise measurements of the object's dimensions.

Through the integration of the components described above, the system can achieve rapid and accurate measurements of an object's weight and volume with minimal manual intervention, thereby streamlining the measurement process in a variety of settings where such capabilities may be required.

Continuing from the previous summary of one implementation, the measurement system includes image sensors designed to capture images of the target measured. These image sensors, in some embodiments, can be one or more cameras 4 that are strategically positioned around the flat platform weight scale base 1 to obtain a plurality of images from different angles. The images are captured with sufficient resolution and clarity to allow distinct features of the target measured 5 to be discernible for further analysis.

Upon capturing the images, the processor 50, which is operatively connected to the one or more cameras 4, processes the images to identify the object. This process may involve comparing the captured images of the target measured 5 to images or data of known objects stored within a database. The processor 50 may be equipped with or accompanied by software capable of utilizing algorithms for pattern recognition, feature extraction, and comparison for the purpose of object identification.

Once the target measured 5 is identified, the system can tag the image data with identifiers pertinent to the object, such as a type, category, or serial number. This information can be utilized to create or update a database entry corresponding to the target measured 5. The metadata associated with the images might include time and date stamps, weight data from the load cell 2, volume data calculated by the processor 50, and any other relevant information that may aid in cataloging and tracking objects within a storage system, inventory management system, or logistics system.

In other embodiments, this object identification can be harnessed for filing purposes, enabling the system to group images and associated data into collections based on object type or other classification criteria. This feature provides an efficient and reliable means to manage a large number of objects and their measurement data.

In some implementations, the camera-based sensors (52, 54) work in conjunction with the one or more cameras 4 to triangulate positions and dimensions, thereby offering a detailed three-dimensional model of the target measured 5. This three-dimensional model, created from the combination of weight data and image data, allows the processor 50 to rapidly compute the volume of the object with high precision.

With the capability of continuous data collection and the potential for automation, such a system may significantly enhance the efficiency and accuracy of object measurement and tracking tasks in a variety of industries, from logistics and warehousing to retail and inventory management.

The recorded weight and calculated volume serve as a basis for further calculations, such as the determination of density or for other processing steps which might include billing based on mass or volume, controlling inventory, providing data to a customer, or interfacing with transport and logistics systems to optimize packing and shipping.

The measurement system and the method thereby provide an all-encompassing solution for weight and volume measurement as well as object identification and database management, leading to optimized operational processes and enhanced data collection and retrieval systems. This holistic approach to measurement and identification ensures that accurate, relevant data is readily available for decision-making and further application across various sectors.

The flat platform weight scale base 1 is constructed from a durable material that is suitable for heavy industrial use. This choice of material ensures robustness and longevity of the platform, allowing it to withstand the rigors of frequent use in harsh environments that are common in industrial settings. The durable material may include, but is not limited to, reinforced steel, industrial-grade aluminum, or any other material known in the art to provide the necessary strength and resistance to wear, corrosion, and impact.

The processor 50, a critical component of the measurement system, is responsible for analyzing the images captured by the one or more cameras 4. Utilizing advanced algorithms, the processor 50 calculates the volume of the target measured 5 by processing the spatial and geometrical information contained within the images. It can also perform additional computations, such as determining the density of the target measured 5, by integrating the weight information obtained from the one or more load cells 2 with the calculated volume.

While one implementation has been described in conjunction with specific embodiments thereof, it is evident that many alternatives, modifications, and variations will be apparent to those skilled in the art. Accordingly, the embodiments of one implementation described herein are intended to be illustrative, not limiting. Various changes may be made without departing from the spirit and scope of one implementation.

The image sensors, such as one or more cameras, are mounted in strategic positions that can include but are not limited to a column, a side wall, or an adjustable arm. The camera placement is designed to maximize the field of view while capturing the necessary images of the target measured. This configuration allows for comprehensive coverage of the target, facilitating accurate volume measurements by ensuring that all dimensions of the target are recorded from different angles.

The adjustable arm is particularly beneficial as it provides flexibility in positioning the camera(s), allowing for the system to adapt to different sizes and shapes of targets measured. In some embodiments, the cameras are mounted on telescoping or articulating segments of the arm, which can be extended or retracted and angled as required. This adjustability is crucial for ensuring that the cameras are always positioned at the optimal distance and angle relative to the target, regardless of its size or positioning on the flat platform weight scale base.

The use of a column or side wall for mounting cameras offers structural stability and can be particularly advantageous in maintaining a fixed reference point for repetitive measurements, thereby reducing the variability that could be introduced by manual repositioning of the cameras. The fixed mounting can also simplify the design of the system and reduce the potential for mechanical failure or the need for recalibration that might be necessitated by frequent positional adjustments.

In embodiments where the system utilizes multiple cameras or a combination of cameras and additional camera-based sensors, the data from each device can be integrated and processed to improve overall accuracy and reliability of the volume measurements. This integration can involve techniques such as sensor fusion, where data from different types of sensors are combined using algorithms that account for the strengths and weaknesses of each sensor type.

The processor employs advanced algorithms to detect the silhouette and contours of the target measured from the captured images. By comparing the silhouettes and contours against the known dimensions of the calibration object, the processor can adjust for scaling and perspective and thus obtain accurate three-dimensional measurements of the target measured. These measurements include length, width, and height, from which the processor calculates the volume of the object.

After calibration, when the target measured is placed on the flat platform weight scale base, the load cells, referenced by 2, measure the weight of the target. Concurrently, the cameras capture images of the target from which the volume is calculated. Integrating the weight data from the load cells with the volume data calculated from the images, the processor can also derive additional information, such as the density of the target measured. The calculated volume and associated weight measurements are then displayed to the user via the digital interface, which bears reference number 3.

The advantage of integrating weight and volume measurement into a single system, with real-time data processing by the processor, lies in the streamlining of measurement operations, reducing the time and complexity associated with using separate instruments for weight and volumetric analysis. Additionally, the system's ability to self-calibrate using a known dimension object ensures ongoing accuracy and reliability in measurements, which is vitally important across many industrial and commercial applications where precision is paramount.

Not only does the digital interface transmit the data, but it is also equipped with storage capabilities. It can temporarily or permanently store the weight data internally or on connected storage devices, which allows for subsequent retrieval for analysis, reporting, and auditing purposes. The stored data can later inform logistics, inventory management, and quality assurance processes.

In line with the software capabilities of the digital interface, it integrates with or incorporates computational functionalities that further analyze the measured data. The computational results gleaned from this analysis can provide additional insights into the characteristics of the target measured, such as identifying trends, discrepancies, or other useful metrics.

Moreover, the inclusion of a processor in the measurement system facilitates the remote processing of the measured data. The processor may be an integral part of the digital interface or a separate entity entirely, such as a remote server or a cloud-based service. The remote processing allows for more advanced data manipulations and analysis, leveraging more powerful computational resources and software applications than what might be available locally at the point of measurement. It also enables the incorporation of the measured data into broader systems, such as enterprise resource planning software, supply chain management platforms, and logistical optimization tools.

In summary, the measurement system's digital interface is a pivotal component that enables the full exploitation of the weight and volume data of the target measured. From the real-time display of weight to the sophisticated transmission, storage, and remote processing of the data, the digital interface ensures that the gathered information is not merely static readings but rather valuable data that can be integrated into the wider operational ecosystem of a business or organization. The interface thus serves as the nexus between the physical measurement conducted by the measurement system and the digital realm where the data can be harnessed for a multitude of practical applications.

In embodiments of one implementation, the capturing of images of the target measured is achieved through the use of camera-based sensors 54 or infrared-based sensors. These sensors are integrated into the measurement system to enhance the precision with which the captured images represent the actual dimensions of the target measured 5.

The camera-based sensors 54 are designed to detect visual features of the target measured using various imaging techniques. These may include standard optical imaging or advanced methods like structured-light scanning which projects a pattern of light onto the target and captures its deformation to infer the three-dimensional shape of the object. This allows the processor 50 to reconstruct a detailed digital model of the target measured 5.

Infrared-based sensors, on the other hand, use infrared light to map the surface of the target measured 5. They function by the object emitting an infrared signal and detecting its heat off the object. The intensity of the signal provides information about the surface characteristics of the object, which can be processed to deduce volume.

The processor 50 may be programmed with various modes of operation depending on the type of target measured 5 and the specific requirements of the measurement task. For instance, it may use simple geometric assumptions for regularly shaped objects like cubes or spheres or more complex models for irregular shapes. Additionally, the processor 50 can integrate weight data obtained by the load cell 2 with volume data to determine the density of the target measured. This comprehensive set of data—weight, volume, and density—can be displayed on the digital interface 3 or transmitted to an external system for further analysis, logging, or control purposes.

The innovative approach of integrating weight and visual data acquisition provides a means of achieving a compact and versatile measurement system that addresses the limitations in the prior art by providing rapid and concurrent determinations of weight and volume for a wide range of objects with minimal manual intervention and a high degree of precision.

The enhancement of the claimed measurement system lies in its ability to capture a volumetric measurement of the object in addition to the weight. The system includes one or more cameras that are strategically positioned to capture images of the object from various angles. A processor is operably connected to the one or more cameras and is primarily responsible for translating the captured images into a volumetric calculation.

To further the integration and automation of the system, the processors are responsible for triggering the image sensors of the cameras to capture the images of the object. This triggering event is synchronized with the detection of weight by the load cells. When an object is detected by the load cells, a signal is sent to the processor which, in turn, prompts the cameras to begin capturing images of the object.

Additionally, the measurement system is capable of calculating the density of the object through the integration of the weight data from the load cells and the volume data derived from the images. The processor executes algorithms that utilize both the weight and volume information to compute the density, providing a comprehensive profile of the object's physical properties.

The system's utility is evident in environments where rapid and accurate measurements of both weight and volume are pertinent. The automated capturing of images upon weight detection streamlines the process, reducing the need for manual intervention and increasing the throughput of the measurement procedure. This incremental advancement in measurement system technology demonstrates a notable step towards efficient and precise inventory management, shipment analysis, and material assessment applications.

By incorporating a wireless communication module, the system expands its functionality by allowing for remote monitoring and data logging opportunities. The external system to which the data is transmitted may be a centralized server, a cloud-based service, or other data acquisition systems that are capable of further analyzing the data for various purposes. These purposes may include inventory management, shipping cost estimation, space optimization in packaging, or any other application where knowledge of an object's weight and volume is critical.

The addition of the wireless communication module not only enhances convenience by eliminating the need to manually transfer data but also enables real-time tracking and monitoring of measurements. It can be particularly useful in logistics and supply chain management where the data can be used to optimize the packaging, loading, and transportation of goods.

In one embodiment, the processor is programmed to execute software that processes the data collected from the load cells and cameras, determining not just the weight and volume but also other derived metrics such as density. The software may also contain algorithms capable of compensating for any discrepancies or irregularities in the measurements to ensure accuracy.

The known object, with its predetermined dimensions, serves as a calibration reference point for the one or more cameras, allowing for adjustments to be made as necessary to maintain the precision of the volume measurements. Once the image processing is complete, and the volume is determined, both the weight and volume data are ready for transmission via the wireless communication module.

The system's ability to perform these operations quickly and accurately addresses the need for efficient and convenient measurement processes. The data transmitted by the wireless communication module to an external system can also be integrated into broader databases and decision-making tools that can use this information to help streamline operations and make more informed business decisions.

One implementation utilizes machine learning algorithms executed by the processor to enhance the accuracy of volume measurements of the object. These algorithms are designed to process the images captured by the one or more cameras to identify geometric characteristics of the object, such as corner points, edges, and surface planes.

The process begins by the camera-based sensors capturing multi-angle images of the object placed on the flat platform weight scale base. The captured images are then forwarded to the processor, where machine learning algorithms are employed to analyze the images. Using advanced image processing techniques, the algorithms detect various geometric features of the object.

Upon identifying the corner points, the processor determines the vertices of the object. This identification is crucial as the position of these points helps to define the boundaries and dimensions of the object. In objects with well-defined edges, the algorithms follow these lines to understand the shape and alignment of the object in three-dimensional space.

Additionally, the processor analyzes the images to recognize the different surface planes of the object. In the case of objects with irregular shapes or that are partially obscured, the processor's ability to discern surface planes becomes essential. The machine learning algorithms piece together the partial views provided by the cameras to create a comprehensive understanding of the object's volume.

Once the corner points, edges, and surface planes are established, the processor calculates the length, width, and height of the object. These dimensions are then used to compute the volume of the object. The integration of machine learning algorithms allows the system to handle a wide variety of object shapes and sizes, from simple rectangular packages to more complex geometries.

The use of machine learning also means that the system can learn from each measurement taken. By analyzing data over time, the system becomes more proficient in handling objects with challenging characteristics such as reflective surfaces, unusual shapes, or soft edges. This iterative improvement contributes to the robustness and versatility of the measurement system.

By integrating weight measurement from the scale with volumetric data from the cameras, one implementation offers a comprehensive solution for determining the physical properties of an object. This dual-capability system is especially useful in logistics, warehousing, and manufacturing environments where efficiency and precision are valued.

Overall, the incorporation of machine learning enables the system not only to carry out accurate volume measurements but also to adapt and improve its performance over time, which is central to the innovative nature of one implementation.

The measurement system as herein described further comprises functionality for object identification and filing in a database. This aspect of the system leverages the one or more cameras to capture images not only to calculate the volume of the target measured but also to identify the target based on its visual characteristics. Using image recognition algorithms, which may be executed by the processor, the system can compare the captured images against a database of known objects to identify the target measured.

Once the object is identified, the system can tag the captured weight and volume data with the identification information. This tagged data can then be filed in a database for future retrieval and analysis. This database can store historical measurement data, identification data, and any other related data points that can provide insights into the measured objects over time.

To facilitate the object identification process, the system may employ machine learning techniques that allow it to improve its recognition accuracy with each object that is measured and identified. The database of known objects can be updated with new entries or modifications to existing entries, which the processor can access to cross-reference and verify the identification of objects.

In an embodiment of one implementation, the camera-based sensors can be optimized to enhance the system's capability for object identification. The sensors may include features such as depth perception, improved resolution, and advanced lighting controls, which provide clearer and more detailed images, essential for accurate object recognition.

The filing of the tagged data in a database also facilitates the generation of reports and analytics. Users of the system can query the database to retrieve information based on specific criteria, such as object type, range of weights, or volumes. This feature makes it possible to quickly assess inventory levels, plan storage space, or prepare shipments that comply with weight and volume restrictions.

This mounting arrangement allows for the precise adjustment of the cameras' field of view, a necessity for capturing the entirety of the target measured from various angles and perspectives. With the ability to alter the orientation, height, and angle, the image sensors can be adapted to targets of various sizes and shapes, thus allowing the system to maintain adaptability and precision across different measurement requirements.

The column or side wall provides a stable and secure vertical structure on which image sensors can be mounted at a fixed height. This is particularly useful in scenarios where the environment around the measurement system is constant, and where the dimensions of the objects to be measured fall within a specific range, thus requiring little to no adjustment.

Additionally, the mounting mechanism of the image sensors could incorporate features that allow for quick and easy adjustment without the need for tools or excessive downtime in operation. This could include features such as telescoping arms, pivot points, and locking mechanisms that are user-friendly and maintain the positional stability of the sensors during operation.

Furthermore, the mounting architecture of the image sensors can also provide a level of protection to the sensors from environmental factors or accidental impacts. For instance, a protective housing or shroud could be included to shield the image sensors from dust, debris, or any mechanical interference that could affect their performance and longevity.

The inclusion of a column, side wall, or adjustable arm thus not only enhances the functionality of the measurement system by improving the flexibility and range of the image sensor deployment, but also contributes to the overall reliability and accuracy of the volume measurements that are a critical function of the system. This in turn ensures compliance with industry standards for precision and quality in weight and volume measurement applications.

In accordance with one embodiment of one implementation, the integrated measurement system includes an important feature that improves the accuracy of volume measurements. This feature involves the use of a known dimension object, often referred to as a calibration artifact or a known object, as part of the calibration process for image processing and dimension calculations.

During operation, the known object is placed on the flat platform weight scale base, and the camera or cameras capture images of this object from different angles. The processor, equipped with image processing software, analyzes the images to establish the scaling parameters and perspective adjustments needed to make precise volumetric measurements of subsequent objects.

Overall, the integration of calibration using a known dimension object into the measurement system facilitates a highly accurate and reliable process for determining the volume of a target measured, complementing the weight data obtained from the load cells and creating a comprehensive dataset for each measured object.

In the detailed description of one implementation, the measurement system is further capable of handling the determination of dimensions for irregular objects, which introduces additional complexity over the measurement of regular or box-shaped objects. The one or more cameras 4 strategically placed around the measurement area are utilized to capture multiple images of an irregular target measured 5 from various angles. Each image captured provides a two-dimensional view of the object 58, and multiple views are necessary to accurately assess the three-dimensional shape of an irregular object.

To compute the volume of the target measured 5, which may not conform to standard geometric shapes, the processor 50 employs advanced algorithms to analyze the images captured by the one or more cameras 4. The algorithms are designed to identify edges, contours, and surfaces of the irregular object 58. These identified features are then used to construct a virtual three-dimensional model of the object. This is achieved by calculating intersections of face planes, corresponding to the surfaces of the object as depicted in the different images.

The face planes are the virtual representations of the object's surfaces as extrapolated from the two-dimensional images. Each camera 4 will capture different sets of edges and corners that compose the irregular object's 58 shape. The processor 50 uses data from camera-based sensors (52, 54), if available, to enhance the accuracy of the edges and contours detected. The algorithms look for common points where edges meet or intersect, and these intersections are used as guide points to define the face planes.

Once all relevant face planes are identified and intersections calculated, the processor 50 uses this information to compute the volume of the irregular object 58. The volume calculation takes into account the spatial relationships between the planes and the enclosed space they define. This method allows for a non-contact volume measurement, which can be essential for objects that are delicate, prone to deformation, or hazardous to touch.

Moreover, this aspect of the system is also beneficial in applications where a precise volume measurement is critical, such as quality control in manufacturing or shipping where space optimization is important. The ability to quickly and accurately measure irregular objects without physical contact or the need to place the object in a fluid to measure displacement is a significant improvement over traditional methods.

The captured images are then transmitted to an image processing module, which may be a separate unit or integrated into the processor responsible for interpreting the weight data. The image processing module employs image analysis algorithms to analyze the captured images and extract geometric data corresponding to the dimensions of the object. These algorithms can perform edge detection, pattern recognition, and other computer vision techniques to accurately determine the length, width, and height of the object.

To enhance the precision of both the weight and dimension measurements, the method may involve calibrating the load cells and the image sensors before the object is measured. Calibration of the load cells involves using standard weights to ensure their accuracy, while calibration of the image sensors can be carried out using objects with known dimensions. The calibration process ensures that the measurement result is not only simultaneous but also highly accurate. Pseudo-code for one embodiment is as follows:

```
# Initialize system
def initialize_system( ):
  calibrate_cameras( )
  load_known_base_dimensions( )
# Calibration using known object
def calibrate_cameras( ):
  for each camera in cameras:
    place_calibration_object_on_scale( )
    capture_image( )
    measure_pixel_dimensions( )
    calculate_pixels_per_unit( )
    store_camera_calibration_data( )
# Main measurement process
def measure_object( ):
  weight = get_weight_from_scale( )
  for each camera in cameras:
    capture_image( )
  object_dimensions = process_images( )
  return object_dimensions, weight
# Image processing
def process_images( ):
  for each camera_image in captured_images:
    detect_object_edges( )
    calculate_object_pixels( )
  combine_multi_camera_data( )
  object_dimensions = convert_pixels_to_real_dimensions( )
  return object_dimensions
# Convert pixels to real dimensions
def convert_pixels_to_real_dimensions( ):
  for each dimension in [length, width, height]:
    pixel_count = get_pixel_count(dimension)
    real_dimension = pixel_count / pixels_per_unit
    # Compare to known base dimensions for verification
    if dimension in [length, width]:
      verify_against_base_dimension(real_dimension)
  return [length, width, height]
# Verification against known base dimensions
def verify_against_base_dimension(measured_dimension):
  base_dimension = get_corresponding_base_dimension( )
  if abs(measured_dimension − base_dimension) > tolerance:
    flag_for_review( )
  else:
    confirm_measurement( )
# Combine data from multiple cameras
def combine_multi_camera_data( ):
  for each dimension in [length, width, height]:
    measurements = [ ]
    for each camera in cameras:
      measurements.append(get_camera_measurement(dimension))
    final_measurement = calculate_weighted_average(measurements)
    set_final_dimension(dimension, final_measurement)
# Main execution
initialize_system( )
while True:
  if object_detected_on_scale( ):
    object_dimensions, weight = measure_object( )
    display_results(object_dimensions, weight)
    store_data(object_dimensions, weight)
```

This pseudo code outlines a system that:
a. Initializes by calibrating cameras and loading known base dimensions.
b. Calibrates each camera using a known object, calculating pixels per unit of measurement.
c. Measures objects by capturing images from multiple cameras when an object is detected on the scale.
d. Processes images to detect edges and calculate object dimensions in pixels.
e. Combines data from multiple cameras, potentially using a weighted average for more accurate results.
f. Converts pixel measurements to real dimensions using the calibration data.
g. Verifies measurements against known base dimensions for length and width.
h. Displays and stores the final measurements along with the weight.

Moreover, the method can also include the use of a known object placed on the weight scale base together with the object being measured. The known object acts as a reference to improve the accuracy of the dimension measurements by providing a scale against which the size of the object is compared.

In some embodiments, the processor can go further to calculate additional properties of the object, such as its density. This additional step involves utilizing the weight provided by the load cells and the volume inferred from the dimensions calculated through image processing. The processor thus provides a comprehensive set of data for the object, including weight, dimensions, and derived properties like density, thereby offering a multi-faceted profile of the object that can be useful in various applications ranging from shipping and logistics to manufacturing and quality control.

The present method simplifies and expedites the measurement process by eliminating the need for separate measurement devices or transferring the object between different measurement stations. As a result, efficiency is increased, and the potential for errors is reduced, leading to more accurate measurements and improved workflow in settings where data on both weight and volume of objects are required.

In a Conveyor-Integrated Configuration, the weight and dimension measurement device would be positioned adjacent to the conveyor belt, creating a seamless transition for packages moving through the warehouse system. The flat platform weight scale base would be installed at the same height as the conveyor, allowing for smooth transfer of packages from the conveyor to the scale. The object would slide from a belt on to the scale base. An optional automated transfer mechanism, such as a pneumatic arm or a small perpendicular conveyor segment, would be used to move packages from the main conveyor onto the scale platform. This ensures consistent placement of packages for accurate measurement. The image sensors (cameras or infrared sensors) would be mounted on adjustable arms or fixed positions around the scale platform. This arrangement allows for capturing images from multiple angles, ensuring accurate dimension measurements regardless of package orientation. The device's microprocessor would be connected to the warehouse management system (WMS) via a wireless communication module. This integration allows for real-time data transmission of weight and dimension measurements directly into the WMS. The following Automated Measurement Process can be done:

Package Detection: As a package moves along the conveyor, sensors detect its presence and trigger the transfer mechanism.

Weight Measurement: Once the package is on the scale platform, the load cells immediately measure its weight.

Image Capture: Simultaneously with weight measurement, the image sensors capture multiple views of the package.

Dimension Calculation: The microprocessor uses machine learning algorithms to process the captured images and calculate the package dimensions.

Data Processing and Transmission: The weight and dimension data are combined and transmitted to the WMS.

Package Return: After measurement, the package is automatically returned to the main conveyor for further processing or sorting.

The system could include barcode scanners or RFID readers to identify and track individual packages, linking measurement data to specific shipments. The device would be capable of rapid measurements to keep pace with high-volume conveyor operations, potentially processing multiple packages per minute. The system would include mechanisms to handle irregularly shaped or oversized packages, possibly diverting them for manual processing. Regular automated calibration routines using known dimension objects would ensure ongoing accuracy, with minimal disruption to warehouse operations. This conveyor-integrated configuration would significantly enhance the efficiency of shipping operations in a warehouse setting, providing accurate, automated measurements for a high volume of packages with minimal human intervention.

The above device embodiments are designed for the simultaneous measurement of weight and dimensions of objects, integrating a high-precision weight scale with multiple dimension measurement sensors. The device processes and displays the collected data on a digital interface, with the capability to transmit the information to external systems, cloud storage, and cloud computing. The invention is particularly useful in industries where accurate and efficient measurement is critical, such as shipping, logistics, packaging, airport luggage check-in, post office, freight companies, forklifts, warehouses, conveyer belts, and manufacturing.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. The Abstract of the Disclosure is provided to comply with 37 C.F.R. 1.72 (b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

1. 1 A device for simultaneous weight and dimension measurement, comprising:
2. A flat platform weight scale base (1) including one or more load cells for measuring weight;
one or more image sensors positioned to capture images of an object (58) placed on the weight scale base platform;
a processor (50) configured to:
i) process signals from the load cells (2) to determine the weight of the object (58);
ii) perform image processing on the captured images, and;
iii) perform image recognition to determine length, width, and height of the object (58);
d) a digital interface (3) for displaying, transmitting, storing, and remotely processing the measured data and computational results.

2. The device of claim 1, wherein the image sensors are camera-based or infrared-based.

3. The device of claim 1, comprising a conveyor coupled to the platform weight scale base to deliver the object (58).

4. The device of claim 1, wherein the load cells (2) trigger the image sensors to capture the object image when weight is detected.

5. The device of claim 1, further comprising a wireless communication module for transmitting data to an external system or cloud for storage.

6. The device of claim 1, wherein the image recognition identifies object (58) geometric characters including corner points, edges, and surface planes to calculate the length, width, and height of the object (58).

7. The device of claim 1, wherein images captured by the image sensors are used for object identification and filing in a database.

8. The device of claim 1, wherein the platform is made of a durable material suitable for heavy industrial use.

9. The device of claim 1, wherein the image sensors are mounted on a column, side wall, or adjustable arm.

10. The device of claim 1, wherein the processor (50) is configured to perform image processing and dimension calculations using a known dimension object for calibration.

11. The method of claim 1, comprising displaying, transmitting, storing, and remotely processing the measured data and computational results through a digital interface (3).

12. The method of claim 1, wherein capturing images comprises using camera-based sensors (54) or infrared-based sensors.

13. The method of claim 1, further comprising triggering the image sensors to capture the object image when weight is detected by the load cells (2).

14. The method of claim 1, further comprising transmitting data to an external system or cloud for storage and further processing and analysis using a wireless communication module.

15. The method of claim 1, wherein executing machine learning algorithms comprises identifying object geometric characters including corner points, edges, and surface planes to calculate the length, width, and height of the object (58).

16. The method of claim 1, further comprising using captured images for object identification and filing in a database.

17. The method of claim 1, further comprising mounting the image sensors on a column, side wall, or adjustable arm.

18. The method of claim 1, further comprising calibrating the image processing and dimension calculations using a known dimension object.

19. The method of claim 1, further comprising determining dimensions of irregular objects by calculating intersections of face planes derived from the captured images.

20. A method for simultaneous weight and dimension measurement of an object (58), comprising:
measuring the weight of the object (58) using one or more load cells in a flat platform weight scale base (1);
capturing one or more images of the object (58) using image sensors positioned around the weight scale base platform;
processing signals from the load cells (2) to determine the weight of the object (58);
performing image processing on the captured images to determine length, width, and height of the object (58).
